(19) United States
(12) Patent Application Publication
(10) Pub. No.: US 2016/0071169 A1
(43) Pub. Date: Mar. 10, 2016

(54) ADVERTISEMENT PLATFORM APPARATUS

(71) Applicant: SK PLANET CO., LTD., Seongnam-si (KR)

(72) Inventor: Min ho HAN, Seoul (KR)

(21) Appl. No.: 14/846,406

(22) Filed: Sep. 4, 2015

(30) Foreign Application Priority Data
Sep. 4, 2014 (KR) 10-2014-0117976
Sep. 4, 2014 (KR) 10-2014-0117978
Sep. 19, 2014 (KR) 10-2014-0125242

(51) Int. Cl. G06Q 30/02

(52) U.S. Cl. CPC G06Q 30/0277; G06Q 30/0264; G06Q 30/0269

(57) ABSTRACT

Provided are an advertisement platform apparatus and a method of operating the same. In other words, a total quantity of advertisements may be smoothly and completely exhausted by suitably distributing total quantity of advertisements registered by advertisers over a total advertisement period by reflecting an actual quantity of advertisements received and exhausted by a terminal apparatus.

### CROSS-REFERENCE TO RELATED APPLICATIONS

The instant application is based on and claims priority to Korean Patent Application No. 10-2014-0117976, filed on Sep. 4, 2014, Korean Patent Application No. 10-2014-0117978, filed on Sep. 4, 2014. and, Korean Patent Application No. 10-2014-0125242, filed on Sep. 19, 2014. The disclosure of above-listed application is hereby incorporated by reference herein in their entirety.

### TECHNICAL FIELD

The present disclosure relates to a method of suitably distributing total quantity of advertisements registered by advertisers over a total advertisement period by reflecting an actual quantity of advertisements received and exhausted by a terminal apparatus.

The present disclosure also relates to a method of designating a targeting application as a targeting condition of advertisements and providing advertisements only to terminal apparatuses having installed thereon the targeting application from among a plurality of terminal apparatuses requesting advertisements.

The present disclosure also relates to a method of uniformly exhausting quantities of advertisements respectively allocated to a plurality of advertisement indexes.

### BACKGROUND ART

Along with rapid expansion of markets of applications, which are advertisement media executed on mobile apparatuses like a smart phone and a tablet pad, advertisement markets related thereto are also rapidly expanding.

Here, a mobile apparatus (referred to hereinafter as a ‘terminal apparatus’) includes an application, which is an advertisement medium, or accesses a web page, which is another advertisement medium.

Such a terminal apparatus receives an advertisement registered by an advertiser from an advertisement platform apparatus and displays the advertisement via an advertisement medium.

Here, in an advertisement platform apparatus, it is necessary to provide a total quantity of advertisements registered by an advertiser to a terminal apparatus and completely exhaust the total quantity of advertisements during a total advertisement period promised with the advertiser.

Therefore, to smoothly and completely exhaust a total quantity of advertisements, a method of suitably distributing the total quantity of advertisements over a total advertisement period by reflecting an actual quantity of advertisements received and exhausted by a terminal apparatus is demanded.

Incidentally, an advertisement platform apparatus may employ a targeting technique for selecting a user satisfying targeting conditions designated by an advertiser and providing advertisements to a terminal apparatus possessed by the selected user.

Here, in the advertisement platform apparatus, a quantity of advertisements to be provided, which is a number of times for providing advertisements, is set during registration of the advertisements and the advertisements are provided only within the designated quantity of advertisements to be provided.

Therefore, the most important factor for obtaining the maximum advertisement effect desired by an advertiser within a limited quantity of advertisements to be provided as described above may be setting of targeting conditions regarding advertisements.

Furthermore, an advertisement platform apparatus classifies a plurality of advertisement indexes based on types, time slots, and priorities of advertisements, selects a particular advertisement index from among the plurality of classified advertisement indexes, and provides advertisements allocated to the selected advertisement index to a terminal apparatus.

However, if advertisement indexes are classified as described above, ratios that advertisements allocated to the respective advertisement indexes are exhausted may differ from one another, and thus advertisements allocated to a particular advertisement index may not be completely exhausted.

### DETAILED DESCRIPTION OF THE INVENTION

### Technical Problem

The present disclosure provides a method of smoothly and completely exhausting a total quantity of advertisements by suitably distributing the total quantity of advertisements over a total advertisement period by reflecting an actual quantity of advertisements received and exhausted by a terminal apparatus is demanded.

The present disclosure also provides a method of designating a targeting application as a targeting condition of advertisements and providing advertisements only to terminal apparatuses having installed thereon the targeting application from among a plurality of terminal apparatuses requesting advertisements, thereby maximizing advertisement effects within a limited quantity of remaining advertisements.

The present disclosure also provides a method of uniformly exhausting respective quantities of advertisements allocated to a plurality of advertisement indexes, thereby preventing incomplete exhaustion of advertisements allocated to a particular advertisement index.

### Technical Solution

According to an aspect of the present disclosure, there is provided an advertisement platform apparatus including an checking part that checks a quantity of exhausted advertisements exhausted to the end of a particular time point within an advertisement period and a target quantity of advertisements to be exhausted that needs to be exhausted to the end of the particular time point; and a control part that, if there is a difference between the quantity of exhausted advertisements and the target quantity of advertisements to be exhausted, allocates a quantity of allocated advertisements reflecting a correction value with respect to time point adjacent to the particular time point, thereby compensating the difference between the quantity of exhausted advertisements and the target quantity of advertisements to be exhausted when the quantity of allocated advertisements is exhausted.

According to another aspect of the present disclosure, there is provided an advertisement platform apparatus including a providing part that, when advertisements are requested by two or more terminal apparatuses having installed thereon a targeting application of a particular advertisement, provides the particular advertisement to a particular terminal apparatus of the two or more terminal apparatuses; and a control part that controls to provide the particular advertisement to the particular terminal apparatus of the two or more terminal apparatuses according to an advertisement providing ratio determined based on preference scores regarding respective targeting applications installed on the two or more terminal apparatuses.

According to another aspect of the present disclosure, there is provided an advertisement platform apparatus including a selecting part that selects a particular advertisement index from among a plurality of advertisement indexes and provides advertisements allocated to the particular advertisement index to a terminal apparatus; and a control part that determines respective selection probabilities regarding the plurality of advertisement indexes based on quantities of remaining advertisements related to advertisements respectively allocated to the plurality of advertisement indexes to enable the selecting part to select the particular advertisement index based on the selection probabilities.

### Advantageous Effects

According to an exemplary embodiment of the present disclosure, an advertisement platform apparatus according to the present disclosure may smoothly and completely exhaust a total quantity of advertisements by suitably distributing the total quantity of advertisements registered by an advertiser over a total advertisement period by reflecting an actual quantity of advertisements received and exhausted by a terminal apparatus.

According to another exemplary embodiment of the present disclosure, an advertisement platform apparatus designates a targeting application as a targeting condition of advertisements and provides advertisements only to terminal apparatuses having installed thereon the targeting application from among a plurality of terminal apparatuses requesting advertisements, thereby maximizing advertisement effects within a limited quantity of remaining advertisements.

According to another exemplary embodiment of the present disclosure, in case of selecting a particular advertisement index from among a plurality of advertisement indexes and providing advertisements allocated to the selected particular advertisement index, an advertisement platform apparatus may set a probability for selecting a particular advertisement index with the largest quantity of remaining advertisements to be higher than a probability for selecting any of the other advertisement indexes, and thus quantities of advertisements allocated to the respective advertisement indexes may be uniformly exhausted.

### DESCRIPTION OF THE DRAWINGS

FIG. 1 is a diagram showing an advertisement providing system according to a first embodiment of the present disclosure;

FIG. 2 is a diagram showing a schematic configuration of the advertisement platform apparatus according to the first embodiment of the present disclosure;

FIG. 3 is a schematic flowchart for describing an operation flow in the advertisement platform apparatus according to the first embodiment of the present disclosure;

FIG. 4 is a diagram showing an advertisement providing system according to a second embodiment of the present disclosure;

FIG. 5 is a diagram showing a schematic configuration of the advertisement platform apparatus according to the second embodiment of the present disclosure;

FIG. 6 is a schematic flowchart for describing an operation flow in the advertisement platform apparatus according to the second embodiment of the present disclosure;

FIG. 7 is a diagram showing a schematic configuration of the advertisement platform apparatus according to the third embodiment of the present disclosure;

FIG. 8 is a diagram showing a schematic configuration of the advertisement platform apparatus according to the third embodiment of the present disclosure;

FIG. 9 is a schematic flowchart for describing an operation flow in the advertisement platform apparatus according to the third embodiment of the present disclosure.

### MODES OF THE INVENTION

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The terms “include” or “is composed of” in this specification are not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Hereinafter, a first embodiment of the present disclosure will be described with reference to the attached drawings.

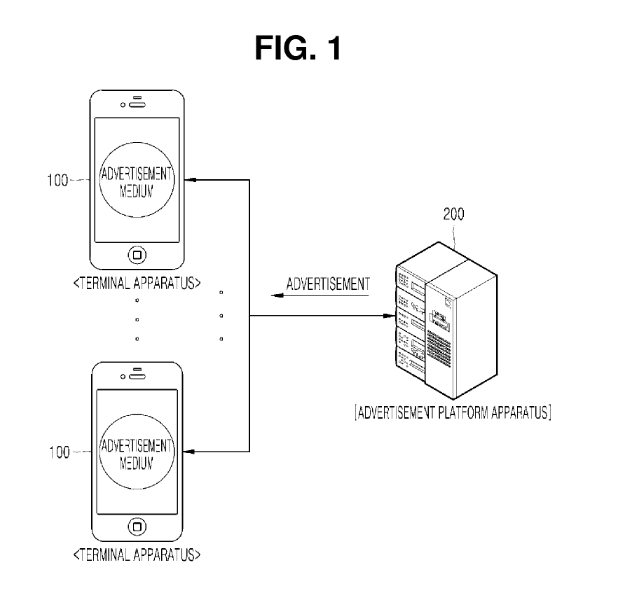

FIG. 1 is a diagram showing an advertisement providing system according to a first embodiment of the present disclosure.

As shown in FIG. 1, the advertisement providing system according to the first embodiment of the present disclosure includes a plurality of terminal apparatuses 100 that receive advertisements and an advertisement platform apparatus 200 that provides advertisements to the plurality of terminal apparatuses 100.

Here, the terminal apparatus 100 refers to an apparatus for executing an application, which is an advertisement medium, or accessing a web page, which is another advertisement medium.

For example, the terminal apparatus 100 may be a smart phone, a tablet PC, a desktop PC, and a laptop PC. However, the present disclosure is not limited thereto, and the terminal apparatus 100 may include any of various apparatuses capable of executing an application, which is an advertisement medium, or accessing a web page.

The advertisement platform apparatus 200 refers to an advertisement server that provides advertisements registered by advertisers to the terminal apparatus 100.

In the advertisement platform apparatus 200, in order to completely exhaust total quantity of advertisements registered by advertisers within a promised total advertisement period, the total advertisement period is divided into a plurality of unit advertisement periods (e.g., days, minutes, etc.), and a quantity of allocated advertisements is allocated to each of the unit advertisement period.

Here, a quantity of allocated advertisements allocated to each unit advertisement period is exhausted by providing advertisements to the plurality of terminal apparatuses 100.

Here, exhaustion of advertisements means that operations as described below are performed at the terminal apparatus 100 in relation to advertisements provided by the advertisement platform apparatus 200.

For example, if an advertisement is a CPM (Cost Per Mile, Cost Per thousand iMperssion, or Cost Per Millennium) type advertisement, exhaustion of the advertisement means that the advertisement provided by the advertisement platform apparatus 200 is normally received and displayed by the terminal apparatus 100.

Furthermore, if type of an advertisement is a CPC (Cost Per Click) advertisement, exhaustion of the advertisement means that, when the advertisement provided by the advertisement platform apparatus 200 is normally received and displayed, a user selecting event (click) occurred in relation to the displayed advertisement.

Here, a quantity of allocated advertisements allocated to each unit advertisement period refers to a basic allocation quantity obtained by dividing a total quantity of advertisements by a number of unit advertisement periods divided from a total advertisement period, where same quantities are generally allocated to the respective unit advertisement periods.

However, in reality, quantities of advertisements exhausted by the terminal apparatus 100 in respective unit advertisement periods differ from one another, and thus a quantity of allocated advertisements may be insufficient or excessive in each of unit advertisement periods.

Therefore, even if a total advertisement period for exhausting a total quantity of advertisements is divided into a plurality of unit advertisement periods and quantities of allocated advertisements are allocated to the respective unit advertisement periods, quantities of advertisements exhausted by the terminal apparatus 100 in respective unit advertisement periods differ from one another, and thus there is a limit for complete and smooth exhaustion of the total quantity of registered advertisements within a promised total advertisement period.

Therefore, according to the first embodiment of the present disclosure, there is provided a method of compensating a difference between a target quantity of advertisements to be exhausted and an actual quantity of advertisements exhausted by the terminal apparatus 100 for complete exhaustion of a total quantity of advertisements. Hereinafter, detailed descriptions of a configuration of the advertisement platform apparatus 200 for embodying the method will be given below.

Here, the total quantity of advertisements refers to a quantity set by an advertiser during registration of advertisements to the advertisement platform apparatus 200, where it is necessary for the terminal apparatus 100 to exhaust advertisements corresponding to the total quantity of advertisements within a total quantity of advertisements promised to the advertiser (e.g., a week).

Furthermore, a quantity of allocated advertisements allocated to each of unit advertisement periods divided from a total advertisement period may refer to a number of times that advertisements may be provided to a terminal apparatus.

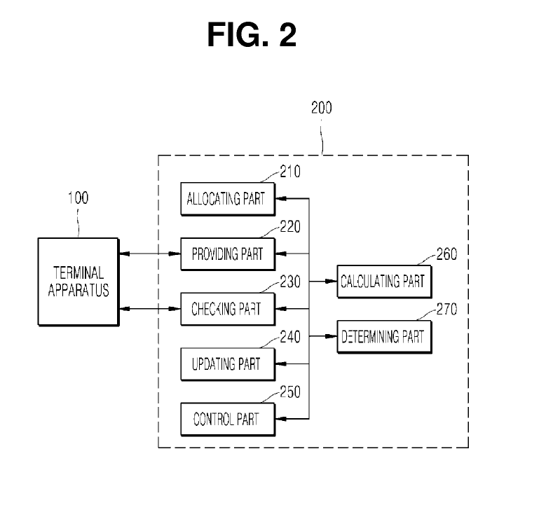

FIG. 2 is a diagram showing a schematic configuration of the advertisement platform apparatus 200 according to the first embodiment of the present disclosure.

As shown in FIG. 2, the advertisement platform apparatus 200 according to the first embodiment of the present disclosure includes an allocating part 210 for allocating quantities of advertisements, a providing part 220 for providing advertisements to advertisement media, a checking part 230 for checking quantities of exhausted advertisements, an updating part 240 for accumulating and updating quantities of exhausted advertisements, and a control part 250 for allocating quantities of advertisements to compensate a difference between an actual quantity of exhausted advertisements and a target quantity of advertisements to be exhausted.

Furthermore, other than the above-stated components, the advertisement platform apparatus 200 according to the first embodiment of the present disclosure may further include a calculating part 260 for calculating a correction value and a determining part 270 for determining a correlation between a quantity of exhausted advertisement and a target quantity of advertisements to be exhausted.

Here, the components of the advertisement platform apparatus 200 including the allocating part 210, the providing part 220, the checking part 230, the updating part 240, the control part 250, the calculating part 260, and the determining part 270 may be embodied as software modules implemented by a processor or may be embodied of combinations thereof.

The allocating part 210 performs a function for setting quantities of allocated advertisements.

In detail, the allocating part 210 divides a total advertisement period for completely exhausting a total quantity of advertisements (e.g., a week) into a plurality of unit advertisement periods (e.g., one day) and allocates quantities of allocated advertisements respectively to the plurality of unit advertisement periods.

Here, in case of initially allocating a quantity of allocated advertisements to a unit advertisement period, the allocating part 210 allocates a basic allocation quantity, which is a value obtained by dividing a total advertisement period by a number of divided unit advertisement periods, as a quantity of allocated advertisements for the corresponding unit advertisement period.

For example, if a total advertisement period is ‘one week’ and a total quantity of advertisements to be completely exhausted during the total advertisement period is ‘700,’ the total advertisement period is divided into total 7 unit advertisement periods, and thus a basic allocation quantity allocated to the unit advertisement periods as a unit quantity of allocated advertisements may be 100 (700/7).

The providing part 220 performs a function for providing advertisements.

In detail, when a quantity of allocated advertisements is allocated to a unit advertisement period, the providing part 220 extracts and provides advertisements corresponding to the quantity of allocated advertisements allocated to the corresponding unit advertisement period based on advertisement requests received from the plurality of terminal apparatuses 100.

The checking part 230 performs a function for checking whether advertisements are exhausted.

In detail, the checking part 230 checks whether advertisements provided to the plurality of terminal apparatuses 100 are normally exhausted during a unit advertisement period, thereby checking a quantity of exhausted advertisement exhausted during the corresponding unit advertisement period.

Here, the checking part 230 may receive notifications from the plurality of terminal apparatuses 100 that advertisements are received and exhausted, thereby checking exhaustion of a quantity of allocated advertisements allocated to a corresponding unit advertisement period.

Here, information notified by the plurality of terminal apparatuses 100 may include, for example, a quantity of provided advertisements indicating quantities of advertisements provided to advertisement media, quantities of exposed advertisements indicating quantities of advertisements displayed (exposed) by each of the terminal apparatuses 100, and quantity of selected advertisements selected (clicked) by each of the terminal apparatuses 100.

Here, the checking part 230 may check a quantity of exposed advertisements or a quantity of selected advertisements based on a type of an advertisement (e.g., CPM, CPC, etc.) provided to an advertisement medium, thereby checking a quantity of exhausted advertisement exhausted from a quantity of allocated advertisements.

In other words, if type of an advertisement is a CPM advertisement, the checking part 230 checks quantities of exposed advertisements displayed (exposed) by the respective terminal apparatuses 100 as quantities of advertisements exhausted from a unit quantity of allocated advertisements.

Alternatively, if type of an advertisement is a CPC advertisement, the checking part 230 checks quantities of selected advertisements selected by the respective terminal apparatuses 100 as quantities of advertisements exhausted from a unit quantity of allocated advertisements.

The updating part 240 performs a function for accumulating and updating checked quantity of exhausted advertisements.

In detail, when quantities of exhausted advertisements exhausted by the respective terminal apparatuses 100 are checked per unit advertisement period, the updating part 240 accumulates and updates the checked quantities of exhausted advertisements, such that the accumulated and updated quantities of exhausted advertisements may be referred to for allocating quantities of advertisement regarding a next unit advertisement period.

The determining part 270 performs a function for determining a correlation between a quantity of exhausted advertisements and a target quantity of advertisements to be exhausted.

In detail, the determining part 270 determines a correlation between quantities of exhausted advertisements accumulated to the end of a current unit advertisement period and a target quantity of advertisements to be exhausted as a parameter for calculating a correction value for compensating a difference between the quantities of exhausted advertisements accumulated to the end of a current unit advertisement period and the target quantity of advertisements to be exhausted.

Here, a target quantity of advertisements to be exhausted refers to a quantity of advertisements that needs to be exhausted by the end of a corresponding unit advertisement period for complete exhaustion of a total quantity of advertisements and refers to a sum of basic allocation quantities allocated to the end of respective unit advertisement periods.

Here, the determining part 270 checks an advertisement exhaustion ratio corresponding to a ratio of accumulated quantities of exhausted advertisements to the total quantity of advertisements as shown in [Equation 1] below and a target advertisement exhaustion ratio corresponding to a ratio of the target quantity of advertisements to be exhausted to the total quantity of advertisements as shown in [Equation 2] below.

Advertisement exhaustion ratio (%)=quantity of exhausted advertisements( [symbol] )/total quantity of advertisements*100 [Equation 1]

Target advertisement exhaustion ratio (%)=target quantity of advertisements to be exhausted/total quantity of advertisements*100 [Equation 2]

As described above, if a total advertisement period is ‘one week’ and a total quantity of advertisements to be completely exhausted during the total advertisement period is ‘700,’ the total advertisement period may be divided into total 7 unit advertisement periods.

In relation thereto, a target quantity of advertisements to be exhausted at the end of a first unit advertisement period is identical to a basic allocation quantity, that is, ‘100 (700/7),’ and a target quantity of advertisements to be exhausted at the end of a second unit advertisement period may be ‘200’ by accumulating the basic allocation quantity of the previous unit advertisement period. In this regard, a target quantity of advertisements to be exhausted at the end of the final unit advertisement period may be identical to a total quantity of advertisements, that is, 700.

Furthermore, when an advertisement exhaustion ratio to the end of a corresponding unit advertisement period and a target advertisement exhaustion ratio are checked, a ratio of advertisement exhaustion to a total advertisement period corresponding to a ratio of the target advertisement exhaustion ratio to the advertisement exhaustion ratio is calculated according to [Equation 3] below, where the calculated ratio may be determined as a first correlation between quantities of exhausted advertisements accumulated to the end of a corresponding unit advertisement period and the target quantity of advertisements to be exhausted.

Ratio of advertisement exhaustion to a total advertisement period (%; first correlation)=advertisement exhaustion ratio (%)/target advertisement exhaustion ratio (%)*100 [Equation 3]

Here, if a value of the ratio of advertisement exhaustion to a total advertisement is below ‘50’ as shown in [Equation 4] below, the value is corrected to 50. Incidentally, if a value of the ratio of advertisement exhaustion to a total advertisement exceeds ‘100’ as shown in [Equation 5] below, the value is corrected to 100.

ratio of advertisement exhaustion to a total advertisement period (%; first correlation)=MAX[50, advertisement exhaustion ratio to total advertisement period (below 50)] [Equation 4]

ratio of advertisement exhaustion to a total advertisement period (%;first correlation)=MIN[100,advertisement exhaustion ratio to total advertisement period (exceeds 100)] [Equation 5]

As described above, since correction of the ratio of advertisement exhaustion to a total advertisement period is an important factor for allocating a quantity of allocated advertisements for a next unit advertisement period as shown in [Equation 4] below, the ratio of advertisement exhaustion to a total advertisement period is corrected to ultimately prevent an adverse effect to allocation of a quantity of allocated advertisements to the next unit advertisement period.

For example, if the ratio of advertisement exhaustion to a total advertisement period is ‘30,’ which is less than ‘50,’ 3.3 times [(100/30(ratio of advertisement exhaustion to a total advertisement period)) more quantity of an advertisements is additionally allocated for allocating a quantity of allocated advertisements to a next unit advertisement period. If a transmission priority of the corresponding advertisements is higher than those of the other advertisements, the allocation of the additional quantity of the advertisements may inflict adverse effect to transmission of the other advertisements.

Therefore, if the ratio of advertisement exhaustion to a total advertisement period is below ‘50,’ the ratio of advertisement exhaustion to a total advertisement period is corrected to ‘50,’ thereby minimizing an effect to an allocation of quantities of allocated advertisements to maximum 2 times (100/50).

quantity of allocated advertisements(next unit advertisement period)=unit quantity of advertisements*[100/ratio of advertisement exhaustion to a total advertisement period (%)] [Equation 6]

Here, the unit quantity of advertisements is a value obtained by dividing a quantity of remaining advertisements other than the accumulated quantities of exhausted advertisements by a number of remaining unit advertisement periods, which are unit advertisement periods not yet elapsed from among the plurality of unit advertisement periods.

Unit quantity of advertisements (e.g., single unit)=quantity of remaining advertisements/number of remaining unit advertisement periods [Equation 7]

Incidentally, in order to determine a correlation between accumulated quantities of exhausted advertisements and the target quantity of advertisements to be exhausted, the determining part 270 may determine a difference between the target advertisement exhaustion ratio and the advertisement exhaustion ratio as the correlation (second correlation), as shown in [Equation 8] below.

second correlation=target advertisement exhaustion ratio (%)−advertisement exhaustion ratio (%) [Equation 8]

The calculating part 260 performs a function for calculating a correction value.

In detail, when determination of a correlation (first correlation or second correlation) between accumulated quantities of exhausted advertisements and a target quantity of advertisements to be exhausted is completed, the calculating part 260 calculates a correction value for allocating a quantity of allocated advertisements with respect to a next unit advertisement period based on the determined correlation.

Here, the calculating part 260 may calculate a correction value based on a first correlation, which is a ratio of advertisement exhaustion to a total advertisement period. In this case, as shown in [Equation 9] below, a real number value obtained by inversely operating the ratio of advertisement exhaustion to a total advertisement period may be obtained as a first correction value.

first correction value=100/ratio of advertisement exhaustion to a total advertisement period [Equation 9]

Incidentally, in case of calculating a correction value based on a second correlation, the calculating part 260 may calculate a result value obtained by multiplying a real number value corresponding to a difference between the target advertisement exhaustion ratio and the advertisement exhaustion ratio (the second correlation) by a total quantity of advertisements as a second correction value.

second correction value=total quantity of advertisements*(target advertisement exhaustion ratio−advertisement exhaustion ratio)/100 [Equation 10]

The control part 250 performs a function for allocating quantities of allocated advertisements by reflecting a correction value.

In detail, when the calculating part 260 completes calculation of a correction value, the control part 250 controls the allocating part 210 to allocate quantities of allocated advertisements with respect to a next unit advertisement period by reflecting the calculated correction value, thereby compensating a difference between an actual quantity of exhausted advertisements to the end of the previous unit advertisement period and a target quantity of advertisements to be exhausted.

In relation thereto, the allocating part 210 checks a unit quantity of advertisements regarding a next unit advertisement period via [Equation 7] above and apply a first correction value or a second correction value to the checked unit quantity of advertisements, thereby allocating the final quantity of allocated advertisements to the next unit advertisement period.

Here, in case of applying the first correction value, as shown in [Equation 6] above, a result obtained by applying a first correspond quantity to a unit quantity of advertisements is allocated as a first quantity of allocated advertisements regarding the next unit advertisement period.

On the other hand, in case of applying the second correction value, as shown in [Equation 11] below, a result obtained by adding a second correspond quantity to a unit quantity of advertisements is allocated as the final quantity of allocated advertisements regarding the next unit advertisement period.

quantity of allocated advertisements(next unit advertisement period)=unit quantity of advertisements+second correction value [Equation 11]

Here, the allocating part 210 allocates a quantity of allocated advertisements greater than the other quantities of allocated advertisements having reflected thereto the first correction value or the second correction value as a quantity of allocated advertisements regarding the next unit advertisement period.

The reason that the allocating part 210 performs the above-stated operation is to deal with a possible insufficiency of a quantity of allocated advertisements.

Incidentally, although the above descriptions are given in relation to a case in which a total advertisement period is divided into unit advertisement days (referred to hereinafter as a ‘unit advertisement day’), an operation for allocating quantities of allocated advertisements with respect to sub-unit advertisement periods obtained by dividing the unit advertisement day into minutes (e.g., one minute) (referred to hereinafter as a ‘unit advertisement minute’) will be further described.

In other words, the determining part 270 performs a function for determining a correlation between a quantity of exhausted advertisements and a target quantity of advertisements to be exhausted.

In detail, the determining part 270 determines a correlation between an accumulated quantity of exhausted advertisements and a target quantity of advertisements to be exhausted as a parameter for calculating a correction value for compensating a difference between a quantity of exhausted advertisements accumulated to the end of a current unit advertisement minute and the target quantity of advertisements to be exhausted.

Here, as shown in [Equation 12], the determining part 270 checks a daily advertisement exhaustion ratio corresponding to a ratio of a quantity of allocated advertisements to a quantity of exhausted advertisements accumulated up to the minute based on a unit advertisement day.

Daily advertisement exhaustion ratio (%)=quantity of exhausted advertisements/quantity of allocated advertisements (daily) [Equation 12]

Furthermore, as shown in [Equation 13] below, the determining part 270 additionally checks a daily target advertisement exhaustion ratio that is a ratio of a quantity of allocated advertisements allocated to a unit advertisement day to a target quantity of exhausted advertisements (minutes) to be completely exhausted to the end of a current unit advertisement minute, for complete exhaustion of quantities of allocated advertisements.

Daily target advertisement exhaustion ratio (%)=target quantity of advertisements to be exhausted (minutes)/quantity of allocated advertisements (daily)*100 [Equation 13]

Here, the target quantity of advertisements to be exhausted refers to a quantity of advertisements that needs to be exhausted to the end of a current unit advertisement minute for complete exhaustion of a quantity of allocated advertisements allocated to a unit advertisement day and refers to an accumulated basic allocated quantity to the end of a current unit advertisement minute.

For example, if a total quantity of advertisements that needs to be exhausted within one day is ‘1440,’ a unit advertisement day may be divided into total 1440 unit advertisement minutes, where a basic allocation quantity allocated to each of the unit advertisement minutes is 1.

In the above-stated example, if 3 hours is elapsed from the initial unit advertisement minute (total 180 unit advertisement minutes are elapsed), an accumulated basic allocation quantity to the corresponding time point is 180 (60*3), where the accumulated basic allocation quantity becomes a target quantity of exhausted advertisements at the corresponding time point.

Furthermore, when a daily advertisement exhaustion ratio and a daily target advertisement exhaustion ratio are checked, the determining part 270 calculates a ratio of an advertisement exhaustion ratio to a unit advertisement day corresponding to a ratio of the daily advertisement exhaustion ratio to the daily target advertisement exhaustion ratio as shown in [Equation 14] below and determine the ratio of an advertisement exhaustion ratio to a unit advertisement day as a correlation between the quantity of exhausted advertisements accumulated up to the minute and the target quantity of advertisements to be exhausted.

Ratio of advertisement exhaustion ratio to unit advertisement day=daily advertisement exhaustion ratio (%)/daily target advertisement exhaustion ratio (%)*100 [Equation 14]

Here, like the above-stated ratio of advertisement exhaustion to a total advertisement period, if a result value is below ‘50,’ the ratio of an advertisement exhaustion ratio to a unit advertisement day is corrected to 50. Furthermore, if a result value exceeds ‘100,’ the ratio of an advertisement exhaustion ratio to a unit advertisement day is corrected to 100.

The calculating part 260 performs a function for calculating a minute correction value.

In detail, when the determining part 270 completes to determine a correlation between a quantity of exhausted advertisements accumulated to the end of a unit advertisement day and a target quantity of advertisements to be exhausted, the calculating part 260 calculates a correction value for allocating a quantity of allocated advertisements regarding a next unit advertisement period based on the determined correlation.

Here, as shown in [Equation 15], the calculating part 260 selects a value smaller than the other from between a ratio of an advertisement exhaustion ratio to a unit advertisement day and a ratio of an advertisement exhaustion to a total advertisement period, which is determined as the correlation, and calculates a real number value obtained via inverse operation of the selected ratio of an advertisement exhaustion ratio to a unit advertisement day or the selected ratio of an advertisement exhaustion to a total advertisement period as a minute correction value.

Here, a minute correction value calculated as a real number value via an inverse operation of the ratio of an advertisement exhaustion ratio to a unit advertisement day may be referred to as a third correction value, whereas a minute correction value calculated as a real number value via an inverse operation of the selected ratio of an advertisement exhaustion to a total advertisement period may be referred to as a fourth correction value.

minute correction value (third correction value or fourth correction value)=100/MIN (ratio of an advertisement exhaustion ratio to a unit advertisement day or ratio of an advertisement exhaustion to a total advertisement period) [Equation 15]

As described above, since a minute correction value is calculated by using an inverse number of the selected value, a greater minute correction value is reflected, and thus a value smaller than the other is selected from between the ratio of advertisement exhaustion to unit advertisement day and the ratio of advertisement exhaustion to a total advertisement period to prevent a possible insufficiency of a quantity of allocated advertisements per minute.

The control part 250 performs a function for allocating a quantity of allocated advertisements per minute by reflecting the minute correction value.

In detail, in order to allocate quantity of allocated advertisements per minute after the end of a unit advertisement day, the control part 250 controls the allocating part 210 to allocation quantities of allocated advertisements by reflecting a calculated minute correction value, thereby compensating a difference between an actual quantity of exhausted advertisements accumulated to the end of the unit advertisement day and a target quantity of advertisements to be exhausted.

Here, as shown in [Equation 16], the allocating part 210 may additionally apply the calculated minute correction value to a result value obtained by converting a quantity of allocated advertisements allocated to a unit advertisement day (referred to hereinafter as a ‘daily quantity of allocated advertisements’) to a quantity per minute, thereby allocating a quantity of allocated advertisements per minute regarding minutes not yet elapsed from among minutes of the unit advertisement day.

quantity of allocated advertisements per minute=quantity of allocated advertisements (daily)/1440*minute correction value [Equation 16]

Here, the quantity of allocated advertisements per minute may be additionally changed according to size of the daily advertisement exhaustion ratio (%) calculated via [Equation 12] above.

For example, if size of the daily advertisement exhaustion ratio is below 100%, it means that the daily advertisement exhaustion ratio is not large. Here, if the quantity of allocated advertisements per minute includes a decimal value (e.g., 95.5), the corresponding decimal value is changed to an upper integer value, such that the quantity of allocated advertisements per minute increased to ‘96’ may be allocated.

On the other hand, if size of the daily advertisement exhaustion ratio exceeds 100%, it means that the daily advertisement exhaustion ratio is large. Here, if the quantity of allocated advertisements per minute includes a decimal value (e.g., 95.5), the corresponding decimal value is changed to a lower integer value, such that the quantity of allocated advertisements per minute decreased to ‘95’ may be allocated.

As described above, a quantity of allocated advertisements per minute is adjusted according to size of the daily advertisement exhaustion ratio, because advertisements are actually exhausted by the terminal apparatus 100 by a natural number unit, not a decimal number unit. Therefore, even a small quantity of allocated advertisements per minute is changed by reflecting an actual advertisement exhaustion ratio thereto, such that advertisements are uniformly exhausted throughout a total advertisement period.

As described above, in a configuration of the advertisement platform apparatus 200 according to the first embodiment of the present disclosure, a total quantity of advertisements registered by an advertiser may be smoothly exhausted within a promised total advertisement period by allocating a quantity of allocated advertisements regarding a unit advertisement period next to a current unit advertisement period to compensate a difference between a quantity of exhausted advertisements checked at the end of a particular unit advertisement period from among a plurality of unit advertisement periods divided from a total advertisement period for completely exhausting a total quantity of advertisements and a target quantity of advertisements to be exhausted that needs to be exhausted to the end of the particular unit advertisement period for complete exhaustion of the total quantity of advertisements.

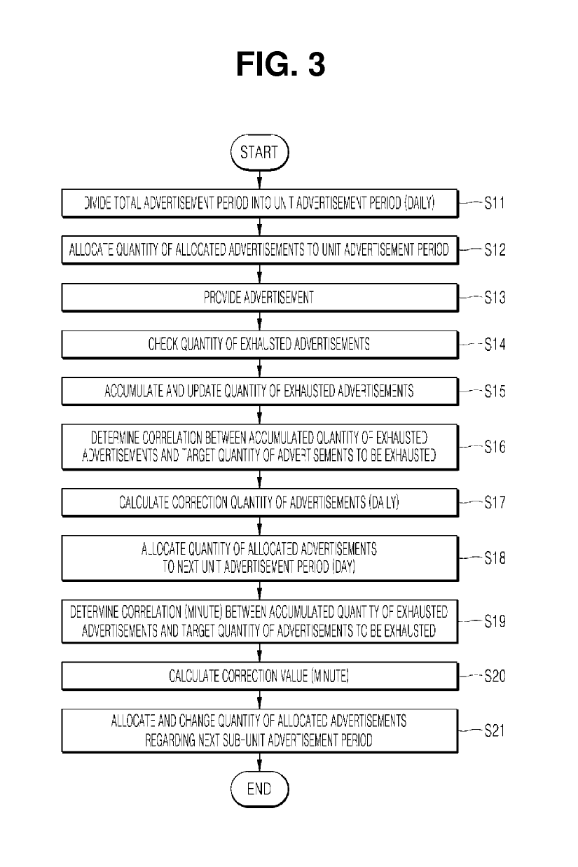

Hereinafter, referring to FIG. 3, an operation flow in the advertisement platform apparatus 200 according to the first embodiment of the present disclosure will be described. For convenience of explanation, the components shown in FIGS. 1 and 2 will be denoted by the same reference numerals.

First, the allocating part 210 divides a total advertisement period for completely exhausting a total quantity of advertisements (e.g., one week) into a plurality of unit advertisement period (e.g., single days) and allocates quantities of allocated advertisements respectively to the plurality of divided unit advertisement periods (operations S11-S12).

Here, in case of initially allocating a quantity of allocated advertisements to a unit advertisement period, the allocating part 210 allocates a basic allocation quantity, which is a value obtained by dividing the total quantity of advertisements by a number of the divided unit advertisement periods, as a quantity of allocated advertisements regarding the corresponding unit advertisement period.

For example, if the total advertisement period is ‘one week’ and the quantity of exhausted advertisements that needs to be completely exhausted during the total advertisement period is ‘700,’ the total advertisement period is divided into 7 unit advertisement periods, and thus the basic allocation quantity allocated to a unit advertisement period as a unit quantity of allocated advertisements may be 100 (700/7).

Next, when a quantity of allocated advertisements is allocated to a unit advertisement period, the providing part 220 extracts and provides advertisements corresponding to the quantity of allocated advertisements allocated to the corresponding unit advertisement period according to advertisement requests received from the plurality of terminal apparatuses 100 (operation S13).

Next, the checking part 230 checks whether the advertisements provided to the plurality of terminal apparatuses 100 are normally exhausted during the corresponding unit advertisement period, thereby checking a quantity of exhausted advertisement exhausted during the corresponding unit advertisement period (operation S14).

Here, the checking part 230 may receive notifications from the plurality of terminal apparatuses 100 that advertisements are received and exhausted, thereby checking exhaustion of a quantity of allocated advertisements allocated to a corresponding unit advertisement period.

Here, information notified by the plurality of terminal apparatuses 100 may include, for example, a quantity of provided advertisements indicating quantities of advertisements provided to advertisement media, quantities of exposed advertisements indicating quantities of advertisements displayed (exposed) by each of the terminal apparatuses 100, and quantity of selected advertisements selected (clicked) by each of the terminal apparatuses 100.

Here, the checking part 230 may check a quantity of exposed advertisements or a quantity of selected advertisements based on a type of an advertisement (e.g., CPM, CPC, etc.) provided to an advertisement medium, thereby checking a quantity of exhausted advertisement exhausted from a quantity of allocated advertisements.

In other words, if type of an advertisement is a CPM advertisement, the checking part 230 checks quantities of exposed advertisements displayed (exposed) by the respective terminal apparatuses 100 as quantities of advertisements exhausted from a unit quantity of allocated advertisements. Alternatively, if type of an advertisement is a CPC advertisement, the checking part 230 checks quantities of selected advertisements selected by the respective terminal apparatuses 100 as quantities of advertisements exhausted from a unit quantity of allocated advertisements.

Next, when quantities of exhausted advertisements exhausted by the respective terminal apparatuses 100 are checked per unit advertisement period, the updating part 240 accumulates and updates the checked quantities of exhausted advertisements, such that the accumulated and updated quantities of exhausted advertisements may be referred to for allocating quantities of advertisement regarding a next unit advertisement period.

Next, the determining part 270 determines a correlation between quantities of exhausted advertisements accumulated to the end of a current unit advertisement period and a target quantity of advertisements to be exhausted as a parameter for calculating a correction value for compensating a difference between the quantities of exhausted advertisements accumulated to the end of a current unit advertisement period and the target quantity of advertisements to be exhausted (operation S16).

Here, the determining part 270 checks an advertisement exhaustion ratio corresponding to a ratio of accumulated quantities of exhausted advertisements to the total quantity of advertisements and a target advertisement exhaustion ratio corresponding to a ratio of the target quantity of advertisements to be exhausted to the total quantity of advertisements.

As described above, if a total advertisement period is ‘one week’ and a total quantity of advertisements to be completely exhausted during the total advertisement period is ‘700,’ the total advertisement period may be divided into total 7 unit advertisement periods.

In relation thereto, a target quantity of advertisements to be exhausted at the end of a first unit advertisement period is identical to a basic allocation quantity, that is, ‘100 (700/7),’ and a target quantity of advertisements to be exhausted at the end of a second unit advertisement period may be ‘200’ by accumulating the basic allocation quantity of the previous unit advertisement period. In this regard, a target quantity of advertisements to be exhausted at the end of the final unit advertisement period may be identical to a total quantity of advertisements, that is, 700.

Furthermore, when an advertisement exhaustion ratio to the end of a corresponding unit advertisement period and a target advertisement exhaustion ratio are checked, a ratio of advertisement exhaustion to a total advertisement period corresponding to a ratio of the target advertisement exhaustion ratio to the advertisement exhaustion ratio is calculated according, where the calculated ratio may be determined as a first correlation between quantities of exhausted advertisements accumulated to the end of a corresponding unit advertisement period and the target quantity of advertisements to be exhausted.

Here, if a value of the ratio of advertisement exhaustion to a total advertisement is below ‘50’, the value is corrected to 50. Incidentally, if a value of the ratio of advertisement exhaustion to a total advertisement exceeds ‘100’, the value is corrected to 100. Here, since correction of the ratio of advertisement exhaustion to a total advertisement period is an important factor for allocating a quantity of allocated advertisements for a next unit advertisement period, the ratio of advertisement exhaustion to a total advertisement period is corrected to ultimately prevent an adverse effect to allocation of a quantity of allocated advertisements to the next unit advertisement period.

Incidentally, in order to determine a correlation between accumulated quantities of exhausted advertisements and the target quantity of advertisements to be exhausted, the determining part 270 may determine a difference between the target advertisement exhaustion ratio and the advertisement exhaustion ratio as the correlation (second correlation).

Next, when determination of a correlation (first correlation or second correlation) between accumulated quantities of exhausted advertisements and a target quantity of advertisements to be exhausted is completed, the calculating part 260 calculates a correction value for allocating a quantity of allocated advertisements with respect to a next unit advertisement period based on the determined correlation (operation S17).

Here, the calculating part 260 may calculate a correction value based on a first correlation, which is a ratio of advertisement exhaustion to a total advertisement period. In this case, a real number value obtained by inversely operating the ratio of advertisement exhaustion to a total advertisement period may be obtained as a first correction value.

Incidentally, in case of calculating a correction value based on a second correlation, the calculating part 260 may calculate a result value obtained by multiplying a real number value corresponding to a difference between the target advertisement exhaustion ratio and the advertisement exhaustion ratio (the second correlation) by a total quantity of advertisements as a second correction value.

Next, when the calculating part 260 completes calculation of a correction value, the control part 250 controls the allocating part 210 to allocate quantities of allocated advertisements with respect to a next unit advertisement period by reflecting the calculated correction value, thereby compensating a difference between an actual quantity of exhausted advertisements to the end of the previous unit advertisement period and a target quantity of advertisements to be exhausted (operation S18).

In relation thereto, the allocating part 210 checks a unit quantity of advertisements regarding a next unit advertisement period and apply a first correction value or a second correction value to the checked unit quantity of advertisements, thereby allocating the final quantity of allocated advertisements to the next unit advertisement period.

Here, in case of applying the first correction value, a result obtained by applying a first correspond quantity to a unit quantity of advertisements is allocated as a first quantity of allocated advertisements regarding the next unit advertisement period.

On the other hand, in case of applying the second correction value, a result obtained by adding a second correspond quantity to a unit quantity of advertisements is allocated as the final quantity of allocated advertisements regarding the next unit advertisement period.

Here, the allocating part 210 allocates a quantity of allocated advertisements greater than the other quantities of allocated advertisements having reflected thereto the first correction value or the second correction value as a quantity of allocated advertisements regarding the next unit advertisement period. The reason that the allocating part 210 performs the above-stated operation is to deal with a possible insufficiency of a quantity of allocated advertisements.

Although the above descriptions are given in relation to a case in which a total advertisement period is divided into unit advertisement days (referred to hereinafter as a ‘unit advertisement day’), an operation for allocating quantities of allocated advertisements with respect to sub-unit advertisement periods obtained by dividing the unit advertisement day into minutes (e.g., one minute) (referred to hereinafter as a ‘unit advertisement minute’) will be further described.

Furthermore, the determining part 270 determines a correlation between an accumulated quantity of exhausted advertisements and a target quantity of advertisements to be exhausted as a parameter for calculating a correction value for compensating a difference between a quantity of exhausted advertisements accumulated to the end of a current unit advertisement minute and the target quantity of advertisements to be exhausted (operation S19).

Here, the determining part 270 checks a daily advertisement exhaustion ratio corresponding to a ratio of a quantity of allocated advertisements to a quantity of exhausted advertisements accumulated up to the minute based on a unit advertisement day.

Furthermore, the determining part 270 additionally checks a daily target advertisement exhaustion ratio that is a ratio of a quantity of allocated advertisements allocated to a unit advertisement day to a target quantity of exhausted advertisements (minutes) to be completely exhausted to the end of a current unit advertisement minute, for complete exhaustion of quantities of allocated advertisements.

Here, the target quantity of advertisements to be exhausted refers to a quantity of advertisements that needs to be exhausted to the end of a current unit advertisement minute for complete exhaustion of a quantity of allocated advertisements allocated to a unit advertisement day and refers to an accumulated basic allocated quantity to the end of a current unit advertisement minute.

For example, if a total quantity of advertisements that needs to be exhausted within one day is ‘1440,’ a unit advertisement day may be divided into total 1440 unit advertisement minutes, where a basic allocation quantity allocated to each of the unit advertisement minutes is 1.

In the above-stated example, if 3 hours is elapsed from the initial unit advertisement minute (total 180 unit advertisement minutes are elapsed), an accumulated basic allocation quantity to the corresponding time point is 180 (60*3), where the accumulated basic allocation quantity becomes a target quantity of exhausted advertisements at the corresponding time point.

Furthermore, when a daily advertisement exhaustion ratio and a daily target advertisement exhaustion ratio are checked, the determining part 270 calculates a ratio of an advertisement exhaustion ratio to a unit advertisement day corresponding to a ratio of the daily advertisement exhaustion ratio to the daily target advertisement exhaustion ratio and determine the ratio of an advertisement exhaustion ratio to a unit advertisement day as a correlation between the quantity of exhausted advertisements accumulated up to the minute and the target quantity of advertisements to be exhausted.

Here, like the above-stated ratio of advertisement exhaustion to a total advertisement period, if a result value is below ‘50,’ the ratio of an advertisement exhaustion ratio to a unit advertisement day is corrected to 50. Furthermore, if a result value exceeds ‘100,’ the ratio of an advertisement exhaustion ratio to a unit advertisement day is corrected to 100.

Next, when the determining part 270 completes to determine a correlation between a quantity of exhausted advertisements accumulated to the end of a unit advertisement day and a target quantity of advertisements to be exhausted, the calculating part 260 calculates a correction value for allocating a quantity of allocated advertisements regarding a next unit advertisement period based on the determined correlation (operation S20).

Here, the calculating part 260 selects a value smaller than the other from between a ratio of an advertisement exhaustion ratio to a unit advertisement day and a ratio of an advertisement exhaustion to a total advertisement period, which is determined as the correlation, and calculates a real number value obtained via inverse operation of the selected ratio of an advertisement exhaustion ratio to a unit advertisement day or the selected ratio of an advertisement exhaustion to a total advertisement period as a minute correction value.

As described above, since a minute correction value is calculated by using an inverse number of the selected value, a greater minute correction value is reflected, and thus a value smaller than the other is selected from between the ratio of advertisement exhaustion to unit advertisement day and the ratio of advertisement exhaustion to a total advertisement period to prevent a possible insufficiency of a quantity of allocated advertisements per minute.

Next, in order to allocate quantity of allocated advertisements per minute after the end of a unit advertisement day, the control part 250 controls the allocating part 210 to allocation quantities of allocated advertisements by reflecting a calculated minute correction value, thereby compensating a difference between an actual quantity of exhausted advertisements accumulated to the end of the unit advertisement day and a target quantity of advertisements to be exhausted (operation S21).

Here, the allocating part 210 may additionally apply the calculated minute correction value to a result value obtained by converting a quantity of allocated advertisements allocated to a unit advertisement day (referred to hereinafter as a ‘daily quantity of allocated advertisements’) to a quantity per minute, thereby allocating a quantity of allocated advertisements per minute regarding minutes not yet elapsed from among minutes of the unit advertisement day.

Here, the quantity of allocated advertisements per minute may be additionally changed according to size of the daily advertisement exhaustion ratio (%).

For example, if size of the daily advertisement exhaustion ratio is below 100%, it means that the daily advertisement exhaustion ratio is not large. Here, if the quantity of allocated advertisements per minute includes a decimal value (e.g., 95.5), the corresponding decimal value is changed to an upper integer value, such that the quantity of allocated advertisements per minute increased to ‘96’ may be allocated.

On the other hand, if size of the daily advertisement exhaustion ratio exceeds 100%, it means that the daily advertisement exhaustion ratio is large. Here, if the quantity of allocated advertisements per minute includes a decimal value (e.g., 95.5), the corresponding decimal value is changed to a lower integer value, such that the quantity of allocated advertisements per minute decreased to ‘95’ may be allocated.

As described above, a quantity of allocated advertisements per minute is adjusted according to size of the daily advertisement exhaustion ratio, because advertisements are actually exhausted by the terminal apparatus 100 by a natural number unit, not a decimal number unit. Therefore, even a small quantity of allocated advertisements per minute is changed by reflecting an actual advertisement exhaustion ratio thereto, such that advertisements are uniformly exhausted throughout a total advertisement period.

As described above, in the operation flow of the advertisement platform apparatus 200 according to the first embodiment of the present disclosure, a total quantity of advertisements registered by an advertiser may be smoothly exhausted within a promised total advertisement period by allocating a quantity of allocated advertisements regarding a unit advertisement period next to a current unit advertisement period to compensate a difference between a quantity of exhausted advertisements checked at the end of a particular unit advertisement period from among a plurality of unit advertisement periods divided from a total advertisement period for completely exhausting a total quantity of advertisements and a target quantity of advertisements to be exhausted that needs to be exhausted to the end of the particular unit advertisement period for complete exhaustion of the total quantity of advertisements.

Hereinafter, a second embodiment of the present disclosure will be described with reference to the attached drawings.

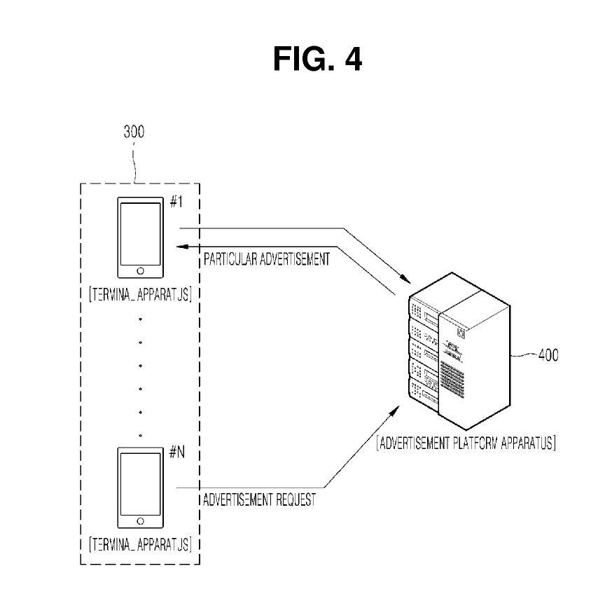

FIG. 4 is a diagram showing an advertisement providing system according to a second embodiment of the present disclosure.

As shown in FIG. 4, the advertisement providing system according to the second embodiment of the present disclosure includes a plurality of terminal apparatuses 300 that request and receive advertisements via an advertisement medium and an advertisement platform apparatus 400 that provides advertisements registered by an advertiser according to advertisement requests received from the terminal apparatuses 300.

The terminal apparatus 300 refers to a mobile apparatus that executes an application, which is an advertisement medium, and receives advertisements and may be a smart phone, a tablet PC, and a PDA. However, the present disclosure is not limited thereto, and the terminal apparatus 300 may include any of various apparatuses capable of executing an application, which is an advertisement medium.

Here, an application installed on the terminal apparatus 300 as an advertisement medium includes a software development kit (SDK) related to reception of advertisements, where a series of operations for receiving and displaying advertisements are performed by the software development kit (SDK) on the terminal apparatus 300.

The advertisement platform apparatus 400 refers to an advertisement server that provides advertisements registered by advertisers to the terminal apparatus 300.

It is supposed that the advertisement platform apparatus 400 employs a pull advertisement technique for providing advertisements registered by an advertiser according to an advertisement request received from the terminal apparatus 300. However, the present disclosure is not limited thereto, and a push advertisement technique for providing advertisements registered by an advertiser without a particular advertisement request from the terminal apparatus 300 may also be employed.

Incidentally, according to the second embodiment of the present disclosure, the advertisement platform apparatus 400 employs a targeting technique for selecting a user satisfying targeting conditions designated by an advertiser and providing advertisements to the terminal apparatus 300 possessed by the selected user.

According to targeting techniques in the related art, targeting conditions of a user, e.g., gender, age, location of residence, and hobby, are designated, users satisfying the designated targeting conditions are selected, and advertisements are provided to the selected users.

However, types and numbers of targeting conditions that may be designated in targeting techniques in the related art are limited and standardized, and thus there is a limit for specifying targets desired by an advertiser.

Furthermore, in the advertisement platform apparatus 400, advertisements are provided only within a quantity of advertisements to be provided designated during registration of the advertisements. Here, it is more difficult to obtain the maximum advertisement effect desired by an advertiser within such a limited quantity of advertisements to be provided.

Therefore, in order to obtain the maximum advertisement effect desired by an advertiser within a limited quantity of advertisements to be provided, a new targeting technique is demanded.

Therefore, the second embodiment of the present disclosure provides a targeting technique for designating an application installed on the terminal apparatus 300 as a targeting condition. Hereinafter, detailed descriptions of the advertisement platform apparatus 400 will be given.

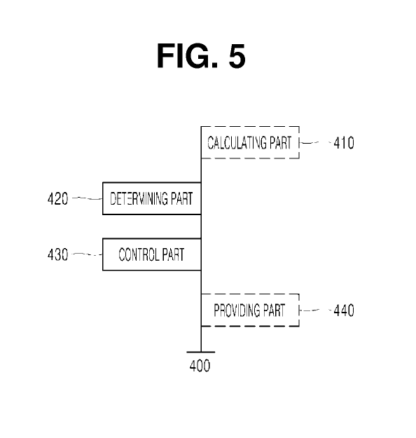

FIG. 5 is a diagram showing a schematic configuration of the advertisement platform apparatus 400 according to the second embodiment of the present disclosure.

As shown in FIG. 5, the advertisement platform apparatus 400 according to the second embodiment of the present disclosure includes a determining part 420 for determining an advertisement providing ratio regarding a particular advertisement and a control part 430 for providing the particular advertisement based on a determined advertisement providing ratio.

Furthermore, other than the above-stated components, the advertisement platform apparatus 400 may further include a calculating part 410 for calculating a preference score regarding an application and a providing part 440 for providing the particular advertisement to the terminal apparatus 300.

Here, the configuration of the advertisement platform apparatus 400 including the calculating part 410, the determining part 420, the control part 430, and the providing part 440 may be entirely or at least partially embodied as a software module or a hardware module or may be embodied of a combination of a software module and a hardware module.

The calculating part 410 performs a function for calculating a preference score regarding an application.

In detail, the calculating part 410 calculates preference scores regarding respective applications installed on the plurality of terminal apparatus 300 to use the applications as targeting conditions.

Here, the calculating part 410 calculates preference score with respect to not only an application including the software development kit (SDK) related to reception of advertisements, but also all other applications, which include even applications without the software development kit (SDK), downloaded to and installed on the terminal apparatuses 300.

To this end, the calculating part 410 collects information regarding a plurality of applications downloaded to and installed on the terminal apparatuses 300 from a particular market server in which the applications are being sold and calculates respective preference scores regarding the plurality of applications based on the collected information.

Here, as shown in [Table 1] below, the information collected from a particular market server may include a download count regarding respective applications, a number of terminal apparatuses 300 to which the respective applications are downloaded for one or more times (referred to hereinafter as a ‘unique download count’), a number of times that the respective applications are installed, and user evaluations regarding the respective applications, where the applications may be categorized based on genres thereof (e.g., game, utility, shopping, etc.).

TABLE 1

| | Installa- | | Unique | | |
|---|---|---|---|---|---|
| Application | tion | Download | Download | User | |
| ID | Count | Count | Count | Evaluation | Category |
| A | 1000 | 1000000 | 10000 | 4.0 | game |
| B | 1000 | 1500000 | 15000 | 4.2 | game |
| C | 800 | 2000000 | 20000 | 4.5 | game |
| D | 500 | 1000000 | 20000 | 3.7 | utility |
| E | 200 | 500000 | 5000 | 4.5 | shopping |

In relation thereto, when information regarding respective applications is collected from a market server, the calculating part 410 calculates preference scores regarding the respective applications. Detailed descriptions thereof will be given below.

In other words, the greater the numbers of times that the application is installed and downloaded are, the higher a preference score regarding an application calculated by the calculating part 410 becomes. To increase reliability of the calculation of preference scores, preference scores are normalized based on a ratio between all applications for preference score calculations and individual applications, where user evaluations, which are direct evaluations of users, are applied as weights.

In relation thereto, as shown in [Equation 17] below, the calculating part 410 calculates preference scores regarding respective applications by multiplying a sum of a ratio of individual download counts to a total download count, a ratio of individual installation counts to a total installation count, and a ratio of individual unique download counts to a total unique download count by user evaluations regarding the respective applications as weights.

preference score=(individual unique download count/total unique download count*100+individual download count/total download count*100+individual installation counts/total installation count*100)*individual user evaluation [Equation 17]

The determining part 420 performs a function for determining an advertisement providing ratio regarding a particular advertisement.

In detail, the determining part 420 checks a targeting application designated by an advertiser during registration of a particular advertisement and determines a advertisement providing ratio regarding the particular advertisement.

Here, the targeting application is designated by an advertiser during a registration of the particular advertisement as a targeting condition regarding the particular advertisement.

Therefore, during registration of advertisements, an advertiser may check preference score calculated for respective applications and select and designate an advertisement having a preference score desired by the advertiser or a category (e.g., game, utility, shopping, etc.) classified based on genres of applications having preference scores desired by the advertiser as a targeting application, where a plurality of applications may be selected and designated as targeting applications.

Here, the advertisement providing ratio refers to a ratio of quantity of advertisements that may be provided to the terminal apparatus 300 having installed thereon the targeting application from a total quantity of advertisements designated to the particular advertisement, where the ratio may be determined as at least part of the designated total quantity of advertisements.

Incidentally, the determining part 420 determines an advertisement providing ratio regarding the particular advertisement based on a preference score calculated with respect to a targeting application designated to the particular advertisement.

In relation thereto, in consideration of reliability, the determining part 420 may determine a ratio of individual preference scores calculated with respect to a targeting application to a total preference score, which is a sum of all preference scores calculated with respect to a plurality of applications, as an advertisement providing ratio regarding the particular advertisement, as shown in [Equation 18].

advertisement providing ratio=individual preference score/all preference scores*100 [Equation 18]

Here, each application is categorized based on a genre thereof (e.g., game, utility, shopping). Here, in terms of determining an advertisement providing ratio, all preference scores reflected to [Equation 18] above may be understood as a sum of preference scores of applications in a same category.

For example, advertisement providing ratios determined in a case where applications are selected as targeting applications based on categories of the respective applications are as shown in [Table 2] below, where values from [Table 1] are actually reflected thereto.

TABLE 2

| | preference | | |
|---|---|---|---|
| application ID | score | advertisement providing ratio | category |
| A | 69.28 | 22.15% | game |
| B | 103.07 | 32.96% | game |
| C | 140.36 | 44.89% | game |
| D | 111.63 | 100% | utility |
| E | 35.07 | 100% | shopping |

Here, if it is assumed that an advertiser selects the category ‘game’ as a targeting application regarding the particular advertisement, a quantity of advertisements corresponding to 22.15% of a total quantity of advertisements may be provided to the terminal apparatus 300 having installed thereon an application A. If both applications A and B are installed on the terminal apparatus 300, a quantity of advertisements corresponding to 55.11% (22.15%+32.96%) of a total quantity of advertisements may be provided to the terminal apparatus 300

The control part 430 performs a function for providing advertisements according to a providing ratio.

In detail, when an advertisement providing ratio regarding the particular advertisement is determined and advertisement requests are received from the plurality of terminal apparatuses 300, the control part 430 controls the providing part 440 to provide the particular advertisement according to the determined advertisement providing ratio.

Here, the control part 430 controls to provide the particular advertisement according to the determined advertisement providing ratio only to the terminal apparatuses 300 having installed thereon a targeting application designated to the particular advertisement from among the plurality of terminal apparatuses 300 requesting advertisements.

As described above with reference to [Table 2], if it is assumed that an advertiser selected the category ‘game’ as a targeting application regarding the particular advertisement, the particular advertisement is only provided to the terminal apparatuses 300 having installed thereon applications A, B, and/or C from among the plurality of terminal apparatuses 300 requesting advertisements.

Here, a quantity of advertisements corresponding to 22.15% of a total quantity of advertisements may be provided to the terminal apparatus 300 having installed thereon the application A, whereas a quantity of advertisements corresponding to 55.11% (22.15%+32.96%) of a total quantity of advertisements may be provided to the terminal apparatus 300 having installed thereon both the applications A and B.

Here, it may be determined whether a targeting application is installed on the terminal apparatus 300 via a software development kit (SDK) included in the terminal apparatus 300. A software development kit (SDK) included in the terminal apparatus 300 collects a list of applications installed on the terminal apparatus 300 before an advertisement request and transmits the collected list of applications to the advertisement platform apparatus 400 during an advertisement request, such that the advertisement platform apparatus 400 that receives the advertisement request may check a list of applications installed on the terminal apparatus 300.

As described above, in the advertisement platform apparatus 200 according to the second embodiment of the present disclosure, a targeting application is designated as a targeting conditions regarding an advertisement and advertisements are provided only to the terminal apparatus 300 having installed thereon the targeting application from among the plurality of terminal apparatuses 300 requesting advertisements, where advertisements may be provided according to a providing ratio determined based on a preference score of the targeting application. Therefore, advertisement effect may be improved within a limited quantity of advertisements to be provided.

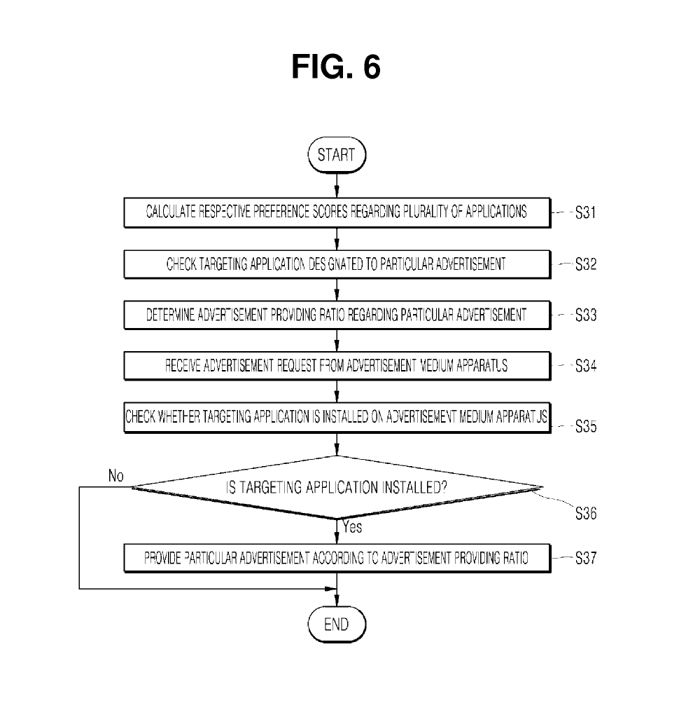

Hereinafter, an operation flow in the advertisement platform apparatus 400 according to the second embodiment of the present disclosure will be described with reference to FIG. 6. For convenience of explanation, the components shown in FIGS. 4 and 5 will be denoted by the same reference numerals.

First, the calculating part 410 calculates preference scores regarding respective applications installed on the plurality of terminal apparatus 300 to use the applications as targeting conditions (operation S31).

Here, the calculating part 410 calculates preference score with respect to not only an application including the software development kit (SDK) related to reception of advertisements, but also all other applications, which include even applications without the software development kit (SDK), downloaded to and installed on the terminal apparatuses 300.

To this end, the calculating part 410 collects information regarding a plurality of applications downloaded to and installed on the terminal apparatuses 300 from a particular market server in which the applications are being sold and calculates respective preference scores regarding the plurality of applications based on the collected information.

In relation thereto, as shown in [Equation 17] above, the calculating part 410 calculates preference scores regarding respective applications by multiplying a sum of a ratio of individual download counts to a total download count, a ratio of individual installation counts to a total installation count, and a ratio of individual unique download counts to a total unique download count by user evaluations regarding the respective applications as weights.

Next, the determining part 420 checks a targeting application designated by an advertiser during registration of a particular advertisement and determines a advertisement providing ratio regarding the particular advertisement (operations S32-S33).

Here, the determining part 420 determines an advertisement providing ratio regarding the particular advertisement based on a preference score calculated with respect to a targeting application designated to the particular advertisement.

In relation thereto, in consideration of reliability, the determining part 420 may determine a ratio of individual preference scores calculated with respect to a targeting application to a total preference score, which is a sum of all preference scores calculated with respect to a plurality of applications, as an advertisement providing ratio regarding the particular advertisement, as shown in [Equation 18] above.

Next, when an advertisement providing ratio regarding the particular advertisement is determined and advertisement requests are received from the plurality of terminal apparatuses 300, the control part 430 controls the providing part 440 to provide the particular advertisement according to the determined advertisement providing ratio (operations S34-S37).

Here, the control part 430 controls to provide the particular advertisement according to the determined advertisement providing ratio only to the terminal apparatuses 300 having installed thereon a targeting application designated to the particular advertisement from among the plurality of terminal apparatuses 300 requesting advertisements.

Here, it may be determined whether a targeting application is installed on the terminal apparatus 300 via a software development kit (SDK) included in the terminal apparatus 300. A software development kit (SDK) included in the terminal apparatus 300 collects a list of applications installed on the terminal apparatus 300 before an advertisement request and transmits the collected list of applications to the advertisement platform apparatus 400 during an advertisement request, such that the advertisement platform apparatus 400 that receives the advertisement request may check a list of applications installed on the terminal apparatus 300.

As described above, in the operation flow of the advertisement platform apparatus 200 according to the second embodiment of the present disclosure, a targeting application is designated as a targeting conditions regarding an advertisement and advertisements are provided only to the terminal apparatus 300 having installed thereon the targeting application from among the plurality of terminal apparatuses 300 requesting advertisements, where advertisements may be provided according to a providing ratio determined based on a preference score of the targeting application. Therefore, advertisement effect may be improved within a limited quantity of advertisements to be provided.

Hereinafter, a third embodiment of the present disclosure will be described with reference to the attached drawings.

FIG. 1 is a diagram showing an advertisement providing system according to a third embodiment of the present disclosure.

As shown in FIG. 1, the advertisement providing system according to the third embodiment of the present disclosure includes a terminal apparatus 500 that receives advertisements from an advertisement platform apparatus 600 and the advertisement platform apparatus 600 that provides advertisements registered by an advertiser to the terminal apparatus 500.

The terminal apparatus 500 refers to an apparatus for receiving advertisements via advertisement media and receives advertisements provided by the advertisement platform apparatus 600 when the terminal apparatus 500 executes an application, which is an advertisement medium, or accesses a web page, which is another advertisement medium.

For example, the terminal apparatus 500 may be a smart phone, a tablet PC, a desktop PC, and a laptop PC. However, the present disclosure is not limited thereto, and the terminal apparatus 500 may include any of various apparatuses capable of executing an application, which is an advertisement medium, or accessing a web page.

The advertisement platform apparatus 600 refers to an advertisement server that provides advertisements registered by advertisers to the terminal apparatus 500.

The advertisement platform apparatus 600 may provide advertisements by using a pull advertisement technique for providing advertisements when an advertisement request is received from the terminal apparatus 500 or a push advertisement technique for providing advertisements without a particular advertisement request from the terminal apparatus 500.

Incidentally, according to the third embodiment of the present disclosure, the advertisement platform apparatus 600 classifies a plurality of advertisement indexes based on types, time slots, and priorities of advertisements, selects a particular advertisement index from among the plurality of classified advertisement indexes, and provides advertisements allocated to the selected advertisement index to the terminal apparatus 500.

As described above, in case of classifying a plurality of advertisement indexes, target quantities of advertisements are respectively designated to advertisements allocated to the respective advertisement indexes by an advertiser, where the advertisement platform apparatus 600 exhausts the advertisements by providing the advertisements allocated to the respective advertisement indexes to the terminal apparatus 500 only within the target quantity of advertisements respectively set to the respective advertisements.

For example, if a target quantity of advertisements set to an advertisement allocated to a particular advertisement is 1000, an advertisement allocated to the particular advertisement may be provided to the terminal apparatus 500 up to 1000 times.

However, if advertisement indexes are classified as described above, ratios that advertisements allocated to the respective advertisement indexes are exhausted may differ from one another, and thus advertisements allocated to a particular advertisement index may not be completely exhausted.

For example, if it is assumed that advertisement indexes are classified based on priorities, the advertisement platform apparatus 600 preferentially provides advertisements allocated to advertisement indexes with higher priorities. Here, it may be anticipated that, if advertisements allocated to the advertisement indexes with higher priorities are not exhausted to a target quantity of advertisements, advertisements allocated to advertisement indexes with lower priorities may not be exhausted at all.

Therefore, the third embodiment of the present disclosure provides a method of uniformly exhausting advertisements respectively allocated to a plurality of advertisement indexes. Hereinafter, detailed descriptions of a configuration of the advertisement platform apparatus 600 to implement the method will be given.

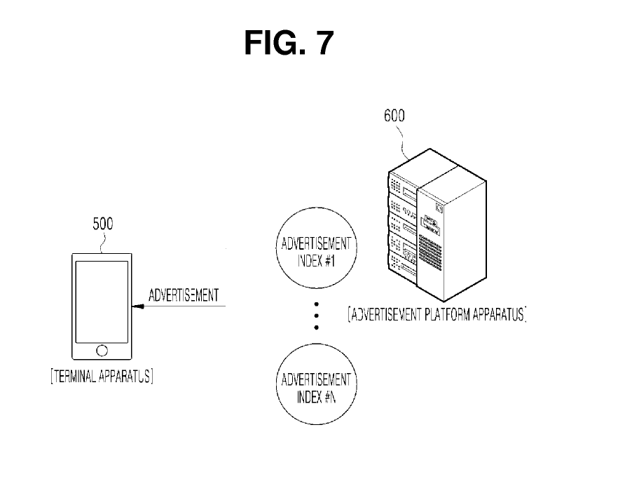

FIG. 7 is a diagram showing a schematic configuration of the advertisement platform apparatus 600 according to the third embodiment of the present disclosure.

As shown in FIG. 7, when an advertisement request is received from the terminal apparatus 500, the advertisement platform apparatus 600 selects a particular advertisement index from among a plurality of advertisement indexes. At this time, the advertisement platform apparatus 600 checks quantity of remaining advertisements with respect to the respective advertisement indexes.

Here, the advertisement platform apparatus 600 may check a quantity of advertisements obtained by subtracting a quantity of provided advertisements from a target quantity of advertisements with respect to each advertisement index as a quantity of remaining advertisements.

Here, although it is described above that a quantity of remaining advertisements is checked when an advertisement request is received from the terminal apparatus 500, the description is under an assumption that the advertisement platform apparatus 600 provides advertisements by using the pull technique. If the advertisement platform apparatus 600 provides advertisements by using the push technique, a quantity of remaining advertisements may be checked without a particular advertisement request from the terminal apparatus 500.

Furthermore, the advertisement platform apparatus 600 performs a function for selecting an particular advertisement index from among a plurality of advertisement indexes.

In detail, when quantities of remaining advertisements regarding the respective advertisement indexes are checked, the advertisement platform apparatus 600 selects a particular advertisement index from among the plurality of advertisement indexes and controls to provide advertisements allocated to the selected particular advertisement index to the terminal apparatus 500.

Here, the advertisement platform apparatus 600 selects an advertisement index by using a pre-defined selection algorithm, such that a particular advertisement index with a large quantity of remaining advertisements is more likely be selected than the other advertisement indexes from among a plurality of advertisement indexes.

Here, the advertisement platform apparatus 600 calculates a total quantity of remaining advertisements by summing quantities of remaining advertisements checked with respect to the respective advertisement indexes and sequentially maps the respective quantities of remaining advertisements in the total quantity of remaining advertisements to a pre-set number system.

Here, the pre-set number system refers to numbers enumerated for mapping a calculated total quantity of remaining advertisements and may be defined as a set of successive integers, for example.

Furthermore, when respective quantities of remaining advertisements in a total quantity of remaining advertisements are mapped to a number system, the advertisement platform apparatus 600 selects an arbitrary number from the mapped number system by using a random function and selects an advertisement index corresponding to the selected arbitrary number.

In other words, in a number system having mapped thereto a total quantity of remaining advertisements, advertisement indexes with large quantities of remaining advertisements occupy the higher percentage. In other words, a probability for selecting a number corresponding to a particular advertisement with the largest quantity of remaining advertisements is higher than a probability of selecting a number corresponding to any of the other advertisement indexes.

Hereinafter, the configuration of the advertisement platform apparatus 600 according to the third embodiment of the present disclosure will be described in closer detail with reference to FIG. 2.

In other words, the advertisement platform apparatus 600 includes a selecting part 610 for selecting an advertisement index and a control part 620 for selecting the advertisement index according to a pre-defined selection algorithm/

Ultimately, the selecting part 610 selects an advertisement index by using the pre-defined selection algorithm based on the above-stated configuration.

Furthermore, other than the above-stated components, the advertisement platform apparatus 600 according to the third embodiment of the present disclosure may further include a providing part 630 for providing advertisements allocated to a selected advertisement index to the terminal apparatus 500.

Here, the configuration of the advertisement platform apparatus 600 including the selecting part 610, the control part 620, and the providing part 630 may be entirely or at least partially embodied as a software module or a hardware module or may be embodied of a combination of a software module and a hardware module.

The selecting part 610 performs a function for checking quantities of remaining advertisements with respect to respective advertisement indexes.

In detail, the selecting part 610 selects a particular advertisement index from among a plurality of advertisement indexes before advertisements are provided to the terminal apparatus 500. At this time, the advertisement platform apparatus 600 checks quantity of remaining advertisements with respect to the respective advertisement indexes.

As described above, target quantities of advertisements are set to advertisements allocated to respective advertisement indexes, where a quantity of remaining advertisements regarding each advertisement index refers to a target quantity of advertisements regarding the corresponding advertisement index less a quantity of advertisements provided to the terminal apparatus 500

Ultimately, as shown in [Equation 19] below, the advertisement platform apparatus 600 may check a quantity of advertisements obtained by subtracting a quantity of provided advertisements from a target quantity of advertisements with respect to each advertisement index as a quantity of remaining advertisements.

Quantity of remaining advertisements=target quantity of advertisements−quantity of provided advertisements [Equation 19]

For example, as shown in [Table 3] below, if it is assumed that advertisement indexes are classified as 0, 1, and 2 and respective target quantities of advertisements allocated to the respective advertisement indexes are set to 1000, 100, and 500, quantities of remaining advertisements checked with respect to the respective advertisement indexes may be as shown below.

TABLE 3

| | Advertisement index | | |
|---|---|---|---|
| | 0 | 1 | 2 |
| Target quantity of advertisement | 1000 | 100 | 500 |
| Quantity of provided advertisements | 100 | 30 | 300 |
| Quantity of remaining advertisements | 900 | 70 | 200 |

Here, since quantities of advertisements provided to the terminal apparatus 500 from the respective advertisement indexes are 100, 30, and 50, a quantity of remaining advertisements regarding the advertisement index ‘0’ may be checked as ‘900,’ a quantity of remaining advertisements regarding the advertisement index ‘1’ may be checked as ‘70,’ and a quantity of remaining advertisements regarding the advertisement index ‘2’ may be checked as ‘200.’

Furthermore, the selecting part 610 performs a function for mapping quantities of remaining advertisements to a pre-set number system.

In detail, when quantities of remaining advertisements regarding the respective advertisement indexes are checked, the selecting part 610 calculates a total quantity of remaining advertisements and maps respective quantities of remaining advertisements in a total quantity of remaining advertisements to the pre-set number system.

Here, the total quantity of remaining advertisements may be calculated by summing quantities of remaining advertisements checked with respect to the respective advertisement indexes, as shown in [Equation 20] below.

Total quantity of remaining advertisements=Σ quantities of remaining advertisements regarding respective advertisement indexes [Equation 20]

For example, as described above with reference to [Table 3], if respective quantities of remaining advertisements checked with respect to the advertisement indexes ‘0, 1, and 2’ are ‘900, 70, and 200,’ the total quantity of remaining advertisements may be ‘1170,’ which is a sum of the respective quantities of remaining advertisements regarding the advertisement indexes.

Furthermore, the pre-set number system refers to numbers enumerated for mapping a calculated total quantity of remaining advertisements and may be defined as a set of successive integers, for example.

As described above, if a calculated total quantity of remaining advertisements is ‘1170,’ the number system may be defined as a set of successive integers {1, 2, 3, . . . , 1170}, where the minimum value is ‘1’ and the maximum value is ‘1170.’ Here, respective quantities of remaining advertisements in the total quantity of remaining advertisements may be sequentially mapped to the respective integers in the order of the advertisement indexes (0→1→2).

In other words, a quantity of remaining advertisements regarding the advertisement ‘0’ may be sequentially mapped to a set of integers from 1 to 900, a quantity of remaining advertisements regarding the advertisement ‘1’ may be sequentially mapped to a set of integers from 901 to 970, and a quantity of remaining advertisements regarding the advertisement ‘2’ may be sequentially mapped to a set of integers from 971 to 1170.

Furthermore, the 610 performs a function for selecting an arbitrary number from a pre-set number system.

In detail, when respective quantities of remaining advertisements in a total quantity of remaining advertisements are mapped to a number system, the selecting part 610 selects an arbitrary number from the mapped number system.

Here, as shown in [Equation 20] below, the selecting part 610 selects an arbitrary number (selected range) from a number system having mapped thereto a total quantity of remaining advertisements by using a random function.

Selected range=quantity of remaining advertisements*(random function value/maximum value that may be obtained by using random function) [Equation 20]

Here, the random function value is a value obtained by using a random function and refers to a range from a number system having mapped thereto the total quantity of remaining advertisements, whereas the maximum value that may be obtained by using the random function refers to the maximum value in the number system having mapped thereto the total quantity of remaining advertisements.

As described above, if respective quantities of remaining advertisements are mapped to a number system defined as a set of successive integers {1, 2, 3, . . . , 1170} with the minimum value of ‘1’ and the maximum value of ‘1170,’ the random function value is a number from 1 to 1170, where the maximum value that may be obtained by using the random function is ‘1170.’

In other words, in a number system having mapped thereto a total quantity of remaining advertisements, advertisement indexes with large quantities of remaining advertisements occupy the higher percentage. In other words, a probability for selecting a number corresponding to a particular advertisement with the largest quantity of remaining advertisements is higher than a probability of selecting a number corresponding to any of the other advertisement indexes.

Furthermore, the selecting part 610 performs a function for selecting an advertisement index.

Furthermore, when an arbitrary number is selected from a number system having mapped thereto a total quantity of remaining advertisements, the selecting part 610 selects a particular advertisement index corresponding to the selected arbitrary number, such that the providing part 630 provides advertisements allocated to the selected particular advertisement index to the terminal apparatus 500.

As described above, if ‘800’ is selected as an arbitrary number from a set of successive integers with the minimum value of ‘1’ and the maximum value of 1170,′ an advertisement index corresponding to ‘800’ is selected.

Here, since it is supposed that a quantity of remaining advertisements regarding the advertisement index ‘0’ is sequentially mapped to a set of integers from 1 to 900, if ‘800’ is selected as an arbitrary number, the advertisement index ‘0’ may be selected.

Here, the selection of an advertisement index may be performed by using the algorithm shown below.

```
Selected_range = selected arbitrary number
for (i=0; i<maximum advertisement quantity; i++)
{
    selected_range = selected_range-“index i quantity of remaining
    advertisements”
    if(selected_range<=0)
    {
        selected advertisement index = i
        break;
    }
}
```

The above algorithm may be understood as described below.

If ‘800’ is selected as an arbitrary number, according to the in-algorithm equation (selected_range=selected_range−“index i quantity of remaining advertisements”), the selected_range has a value ‘−100’ that is obtained by subtracting ‘900’ (that is, a quantity of remaining advertisements regarding the advertisement index) from the selected arbitrary number ‘800.’ Since the value of the selected_range is smaller than ‘0,’ the advertisement index may be selected as ‘0’, an advertisement index corresponding to the selected arbitrary number.

If ‘950’ is selected as an arbitrary number, according to the in-algorithm equation (selected_range=selected_range−“index i quantity of remaining advertisements”), ‘900’ (that is, a quantity of remaining advertisements regarding the advertisement index ‘0’) is subtracted from the selected arbitrary number ‘950.’ In this case, the selected_range has a value ‘50,’ which is greater than 0, ‘70’ (that is, a quantity of remaining advertisements regarding the second advertisement index ‘1’) is sequentially applied to the in-algorithm equation (selected_range=selected_range−“Index i quantity of remaining advertisements”).

Here, the arbitrary number is replaced to a value ‘50,’ which is a number obtained by subtracting ‘900’ (that is, quantity of remaining advertisements regarding the advertisement index ‘0’) from the arbitrary number ‘950’ selected by the algorithm, from ‘1010.’

In other words, according to the in-algorithm equation (selected range=selected_range−“Index i quantity of remaining advertisements”), a value of the selected_range becomes ‘−20,’ which is a value obtained by subtracting ‘70’ (that is, a quantity of remaining advertisements regarding the advertisement index ‘1’) from the replaced arbitrary number ‘50.’ Since the value of the selected_range is smaller than 0, the advertisement index ‘1’ may be selected as an advertisement index corresponding to the selected arbitrary number.

As described above, according to the advertisement providing system according to the third embodiment of the present disclosure, in case of selecting a particular advertisement index from among a plurality of advertisement indexes and providing advertisements allocated to the selected particular advertisement index, a probability for selecting a particular advertisement with the largest quantity of remaining advertisements is set to be higher than a probability for selecting any of the other advertisement indexes, and thus quantities of advertisements allocated to the respective advertisement indexes may be uniformly exhausted.

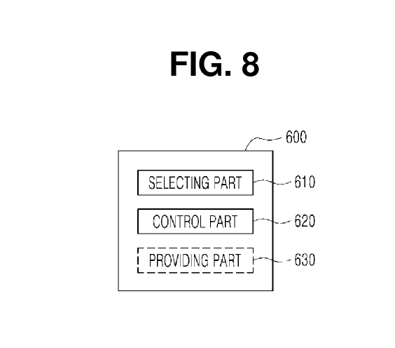

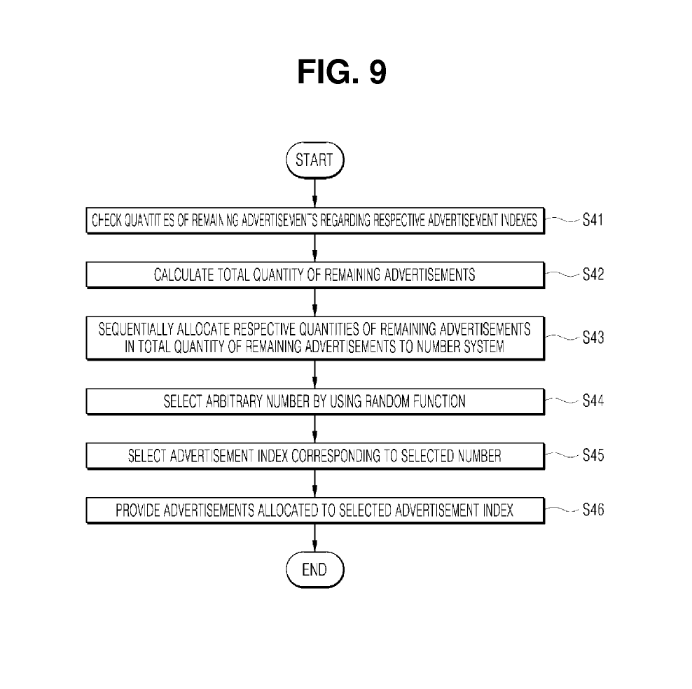

Hereinafter, an operation flow in the advertisement platform apparatus 600 according to the third embodiment of the present disclosure will be described with reference to FIG. 9. For convenience of explanation, the components shown in FIGS. 7 and 8 will be denoted by the same reference numerals.

First, the selecting part 610 selects a particular advertisement index from among a plurality of advertisement indexes before advertisements are provided to the terminal apparatus 500. At this time, the advertisement platform apparatus 600 checks quantity of remaining advertisements with respect to the respective advertisement indexes (operation S41).

Target quantities of advertisements are set to advertisements allocated to respective advertisement indexes, where a quantity of remaining advertisements regarding each advertisement index refers to a target quantity of advertisements regarding the corresponding advertisement index less a quantity of advertisements provided to the terminal apparatus 500

Ultimately, the advertisement platform apparatus 600 may check a quantity of advertisements obtained by subtracting a quantity of provided advertisements from a target quantity of advertisements with respect to each advertisement index as a quantity of remaining advertisements.

For example, if it is assumed that advertisement indexes are classified as 0, 1, and 2, respective target quantities of advertisements allocated to the respective advertisement indexes are set to 1000, 100, and 500, and quantities of advertisements provided to the terminal apparatus 500 from the respective advertisement indexes are 100, 30, and 50, a quantity of remaining advertisements regarding the advertisement index ‘0’ may be checked as ‘900,’ a quantity of remaining advertisements regarding the advertisement index ‘1’ may be checked as ‘70,’ and a quantity of remaining advertisements regarding the advertisement index ‘2’ may be checked as ‘900.’

Next, when respective quantities of remaining advertisements regarding the respective advertisement indexes are checked, the selecting part 610 calculates a total quantity of remaining advertisements by summing the checked quantities of remaining advertisements and sequentially maps respective quantities of remaining advertisements in the total quantity of remaining advertisements to a pre-set number system (operations S42-S43).

As described above, if respective quantities of remaining advertisements checked with respect to the advertisement indexes ‘0, 1, and 2’ are ‘900, 70, and 200,’ the total quantity of remaining advertisements may be ‘1170,’ which is a sum of the respective quantities of remaining advertisements regarding the advertisement indexes.

Here, the pre-set number system refers to numbers enumerated for mapping a calculated total quantity of remaining advertisements and may be defined as a set of successive integers, for example.

As described above, if a calculated total quantity of remaining advertisements is ‘1170,’ the number system may be defined as a set of successive integers {1, 2, 3, . . . , 1170}, where the minimum value is ‘1’ and the maximum value is ‘1170.’ Here, respective quantities of remaining advertisements in the total quantity of remaining advertisements may be sequentially mapped to the respective integers in the order of the advertisement indexes (0→1→2).

In other words, a quantity of remaining advertisements regarding the advertisement ‘0’ may be sequentially mapped to a set of integers from 1 to 900, a quantity of remaining advertisements regarding the advertisement ‘1’ may be sequentially mapped to a set of integers from 901 to 970, and a quantity of remaining advertisements regarding the advertisement ‘2’ may be sequentially mapped to a set of integers from 971 to 1170.

In detail, when respective quantities of remaining advertisements in a total quantity of remaining advertisements are mapped to a number system, the selecting part 610 selects an arbitrary number from the mapped number system (operation S44).

Here, the selecting part 610 selects an arbitrary number (selected range) from a number system having mapped thereto a total quantity of remaining advertisements by using a random function.

Here, the random function value is a value obtained by using a random function and refers to a range from a number system having mapped thereto the total quantity of remaining advertisements, whereas the maximum value that may be obtained by using the random function refers to the maximum value in the number system having mapped thereto the total quantity of remaining advertisements.

As described above, if respective quantities of remaining advertisements are mapped to a number system defined as a set of successive integers {1, 2, 3, . . . , 1170} with the minimum value of ‘1’ and the maximum value of ‘1170,’ the random function value is a number from 1 to 1170, where the maximum value that may be obtained by using the random function is ‘1170.’

In other words, in a number system having mapped thereto a total quantity of remaining advertisements, advertisement indexes with large quantities of remaining advertisements occupy the higher percentage. In other words, a probability for selecting a number corresponding to a particular advertisement with the largest quantity of remaining advertisements is higher than a probability of selecting a number corresponding to any of the other advertisement indexes.

Next, when an arbitrary number is selected from a number system having mapped thereto a total quantity of remaining advertisements, the selecting part 610 selects a particular advertisement index corresponding to the selected arbitrary number, such that the providing part 630 provides advertisements allocated to the selected particular advertisement index to the terminal apparatus 500.

As described above, if ‘800’ is selected as an arbitrary number from a set of successive integers with the minimum value of ‘1’ and the maximum value of 1170,′ an advertisement index corresponding to ‘800’ is selected.

Here, since it is supposed that a quantity of remaining advertisements regarding the advertisement index ‘0’ is sequentially mapped to a set of integers from 1 to 900, if ‘800’ is selected as an arbitrary number, the advertisement index ‘0’ may be selected.

As described above, in the operation flow in the advertisement platform apparatus 600 according to the third embodiment of the present disclosure, in case of selecting a particular advertisement index from among a plurality of advertisement indexes and providing advertisements allocated to the selected particular advertisement index, a probability for selecting a particular advertisement with the largest quantity of remaining advertisements is set to be higher than a probability for selecting any of the other advertisement indexes, and thus quantities of advertisements allocated to the respective advertisement indexes may be uniformly exhausted.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc., in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or sub combinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

1. An advertisement platform apparatus comprising:
an checking part that checks a quantity of exhausted advertisements exhausted to the end of a particular time point within an advertisement period and a target quantity of advertisements to be exhausted that needs to be exhausted to the end of the particular time point; and
a control part that, if there is a difference between the quantity of exhausted advertisements and the target quantity of advertisements to be exhausted, allocates a quantity of allocated advertisements reflecting a correction value with respect to a time point adjacent to the particular time point, thereby compensating the difference between the quantity of exhausted advertisements and the target quantity of advertisements to be exhausted when the quantity of allocated advertisements is exhausted.

2. The advertisement platform apparatus of claim 1, wherein the quantity of allocated advertisements is allocated to the adjacent time point only when the quantity of exhausted advertisements is smaller than the target quantity of advertisements to be exhausted.

3. The advertisement platform apparatus of claim 1, wherein the correction value is applied to a unit quantity of advertisements allocated to the adjacent time point as a weight or applied as an additional quantity of advertisements added to the unit quantity of advertisements.

4. The advertisement platform apparatus of claim 3, wherein the unit quantity of advertisements is allocated to the adjacent time point to exhaust a quantity of remaining advertisements, which is a quantity of advertisements other than the quantity of exhausted advertisements in a total quantity of advertisements that needs to be exhausted during the advertisement period, during an advertisement period after the particular time point.

5. The advertisement platform apparatus of claim 1, wherein the correction value is determined based on a correlation between an advertisement exhaustion ratio, which is a ratio of the quantity of exhausted advertisements to the total quantity of advertisements that needs to be exhausted during the advertisement period, and a target advertisement exhaustion ratio, which is a ratio of the target quantity of advertisements to the total quantity of advertisements.

6. The advertisement platform apparatus of claim 5, wherein the correlation is a ratio of the advertisement exhaustion ratio to the target advertisement exhaustion ratio or a difference between the target advertisement exhaustion ratio and the advertisement exhaustion ratio.

7. An advertisement platform apparatus comprising:
a providing part that, when advertisements are requested by two or more terminal apparatuses having installed thereon a targeting application of a particular advertisement, provides the particular advertisement to a particular terminal apparatus of the two or more terminal apparatuses; and
a control part that controls to provide the particular advertisement to the particular terminal apparatus of the two or more terminal apparatuses according to an advertisement providing ratio determined based on preference scores regarding respective targeting applications installed on the two or more terminal apparatuses.

8. The advertisement platform apparatus of claim 7, wherein the advertisement providing ratio is determined as a ratio proportional to sizes of the respective preference scores of the targeting applications installed on the two or more terminal apparatuses.

9. The advertisement platform apparatus of claim 7, wherein, if two or more targeting applications are installed on the particular terminal apparatus and a result of summing advertisement providing ratios respectively determined with respect to the two or more targeting applications is greater than an advertisement providing ratio determined with respect to a targeting application installed on the other terminal apparatus, the control part provides the particular advertisement to the particular terminal apparatus.

10. An advertisement platform apparatus comprising:
a selecting part that selects a particular advertisement index from among a plurality of advertisement indexes and provides advertisements allocated to the particular advertisement index to a terminal apparatus; and
a control part that determines respective selection probabilities regarding the plurality of advertisement indexes based on quantities of remaining advertisements related to advertisements respectively allocated to the plurality of advertisement indexes to enable the selecting part to select the particular advertisement index based on the selection probabilities.

11. The advertisement platform apparatus of claim 10, wherein the selection probabilities are determined as probabilities proportional to sizes of the quantities of remaining advertisements.

12. The advertisement platform apparatus of claim 10, wherein the selecting part selects an arbitrary range within an index selecting range designated to each of the plurality of advertisement indexes to a size corresponding to the selection probability, and, if the selected arbitrary range is a selected range designated to the particular advertisement index, provides advertisements allocated to the particular advertisement index to the terminal apparatus.
